(19) United States
(12) Patent Application Publication
(10) Pub. No.: US 2025/0028232 A1
(43) Pub. Date: Jan. 23, 2025

(54) ILLUMINATOR AND PROJECTOR

(71) Applicant: SEIKO EPSON CORPORATION, Tokyo (JP)

(72) Inventor: Koichi AKIYAMA, AZUMINO-SHI (JP)

(21) Appl. No.: 18/778,060

(22) Filed: Jul. 19, 2024

(30) Foreign Application Priority Data
Jul. 21, 2023 (JP) 2023-118902

(51) Int. Cl. G03B 21/16; G03B 21/20

(52) U.S. Cl. CPC G03B 21/16; G03B 21/2013; G03B 21/208

(57) ABSTRACT

An illuminator includes a first light source that emits first light; a diffuser including a substrate having a diffusion surface that diffuses light and a driver that rotates the substrate; a light collector that collects the light toward the diffusion surface; and a collimator that parallelizes the light emitted from the diffuser. The first light source includes a plurality of first light emitters that each emit the first light having a first wavelength band, a plurality of second light emitters that each emit the first light having a second wavelength band, a first heat dissipation member to which heat of the first light emitters is transferred, and a second heat dissipation member to which heat of the second light emitters is transferred. A first heat dissipation capability of the first heat dissipation member and a second heat dissipation capability of the second heat dissipation member differ from each other.

The present application is based on, and claims priority from JP Application Serial Number 2023-118902, filed Jul. 21, 2023, the disclosure of which is hereby incorporated by reference herein in its entirety.

### BACKGROUND

### 1. Technical Field

The present disclosure relates to an illuminator and a projector.

### 2. Related Art

In recent years, to enhance the performance of projectors, an illuminator including a laser light source, which is a light source that has a wide color gamut and operates at high efficiency, has been proposed, and a projector including the illuminator has also been proposed.

For example, in the projector disclosed in JP-A-2019-078906, three types of color light output from a red light source array including laser light sources that each output red light, a green light source array including laser light sources that each output green light, and a blue light source array including laser light sources that each output blue light are combined with each other by a light combining system, and the combined light enters a light collection lens, which collects the combined light and outputs the collected combined light toward a diffusion plate. In the projector disclosed in JP-A-2019-078906, the collected combined light passes through the diffusion plate, which reduces speckle noise that appears in a projection image.

For example, the light source apparatus disclosed in JP-A-2021-057512 can be used in an illuminator and a projector, and includes a plurality of first laser devices that each emit light having the same wavelength and a plurality of second laser devices that each emit light having the same wavelength. The wavelength of the light emitted from the second laser devices is shorter than the wavelength of the light emitted from the first laser devices.

JP-A-2019-078906 is an example of the related art.

JP-A-2021-057512 is another example of the related art.

In the projector disclosed in JP-A-2019-078906, merely irradiating the diffusion plate with the combined light collected by the light collection lens and outputting the diffused combined light from the diffusion plate does not sufficiently reduce the speckle noise, and it is desired to improve the speckle noise reduction. In the light source apparatus disclosed in JP-A-2021-057512, since the wavelength of the light emitted from the second laser devices is shorter than the wavelength of the light emitted from the first laser devices, the light emitted from the first laser devices and the light emitted from the second laser devices hardly interfere with each other. Even when the light source apparatus disclosed in JP-A-2021-057512 is used, the difference in wavelength between the light from the first laser devices and the light from the second laser devices is not large, so that speckle noise is not sufficiently reduced, and further improvement in speckle noise reduction is desired.

### SUMMARY

An illuminator according to an aspect of the present disclosure includes a first light source that emits first light having a first color; a second light source that emits second light having a color different from the first color, a light combining member that combines the first light and the second light with each other and emits the combined light, a diffuser including a substrate having a diffusion surface that diffuses the combined light incident thereon and emits the diffused combined light, and a driver that rotates the substrate, a light collector that is disposed between the light combining member and the diffuser, collects the combined light, and causes the collected combined light to be incident on the diffusion surface of the diffuser; and a collimator that parallelizes the combined light emitted from the diffuser. The first light source includes a plurality of first light emitters that each emit the first light having a first wavelength band, a plurality of second light emitters that each emit the first light having a second wavelength band different from the first wavelength band, a first heat dissipation member to which heat of the plurality of first light emitters is transferred, and a second heat dissipation member to which heat of the plurality of second light emitters is transferred. A first heat dissipation capability of the first heat dissipation member and a second heat dissipation capability of the second heat dissipation member differ from each other.

### BRIEF DESCRIPTION OF THE DRAWINGS

FIG. 1 is a schematic view showing the configuration of a projector according to a first embodiment.

FIG. 2 is a schematic view of an illuminator of the projector shown in FIG. 1.

FIG. 3 is a schematic view of a substrate of a diffuser of the illuminator shown in FIG. 2.

FIG. 4 is a schematic view of the illuminator of the projector according to a second embodiment.

FIG. 5 is a perspective view of the illuminator of the projector according to a third embodiment.

FIG. 6 is a plan view of the illuminator shown in FIG. 5.

FIG. 7 is a perspective view of a variation of the illuminator of the projector according to the third embodiment.

FIG. 8 is a plan view of the illuminator shown in FIG. 7.

### DESCRIPTION OF EMBODIMENTS

Embodiments of the present disclosure will be described below with reference to the drawings. In the drawings, components are drawn at different dimensional scales in some cases for clarification of each of the components.

### First Embodiment

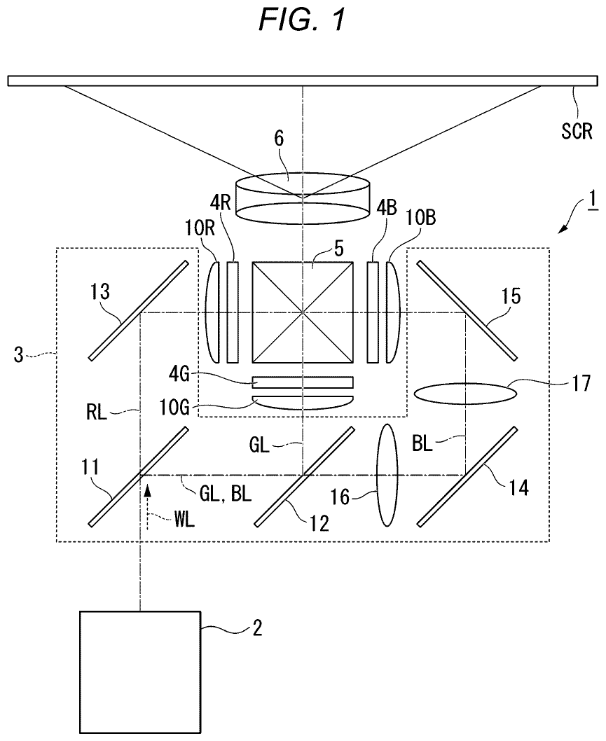

A projector 1 according to a first embodiment of the present disclosure will first be described with reference to FIG. 1. FIG. 1 is a schematic view showing the configuration of the projector 1. The projector 1 is a projection-type image display apparatus that displays video images on a screen SCR. The projector 1 includes an illuminator 2, a color separation system 3, light modulators 4R, 4G, and 4B, a light combining system 5, and a projection system 6. The projector 1 is a three-panel projector including three light modulators.

The illuminator 2 outputs white light WL toward the color separation system 3. The white light WL is illumination light in the projector 1, and contains red light RL, green light GL, and blue light BL. The configuration of the illuminator 2 will be described later.

The color separation system 3 separates the white light WL into the red light RL, the green light GL, and the blue light BL. The color separation system 3 includes, for example, a first dichroic mirror 11, a second dichroic mirror 12, a first total reflection mirror 13, a second total reflection mirror 14, a third total reflection mirror 15, a first relay lens 16, and a second relay lens 17.

The first dichroic mirror 11 is disposed in the optical path of the white light WL output from the illuminator 2, and separates the incident white light WL into the red light RL and light containing the green light GL and the blue light BL. The first dichroic mirror 11 transmits the red light RL and reflects the green light GL and the blue light BL. The second dichroic mirror 12 is disposed in the optical path common to the green light GL and the blue light BL output from the first dichroic mirror 11, and separates the green light GL and the blue light BL from each other. The second dichroic mirror 12 transmits the blue light BL and reflects the green light GL.

The first total reflection mirror 13 reflects the red light RL toward the light modulator 4R. The second total reflection mirror 14 and the third total reflection mirror 15 guide the blue light BL to the light modulator 4B. The green light GL is reflected off the second dichroic mirror 12 toward the light modulator 4G. The red light RL, the green light GL, and the blue light BL contained in the white light WL correspond to the light output from the illuminator 2.

The first relay lens 16 is disposed in the optical path of the blue light BL between the second dichroic mirror 12 and the second total reflection mirror 14. The second relay lens 17 is disposed in the optical path of the blue light BL between the second total reflection mirror 14 and the third total reflection mirror 15. The arrangement of the first relay lens 16 and the second relay lens 17 described above compensates for optical loss of the blue light BL. The optical loss of the blue light BL is caused by the fact that the optical path length of the blue light BL from the first dichroic mirror 11 to the light modulator 4B is longer than the optical path length of the red light RL from the first dichroic mirror 11 to the light modulator 4R and the optical path length of the green light GL from the first dichroic mirror 11 to the light modulator 4G.

The light modulator 4R is disposed in the optical path of the red light RL reflected off the first total reflection mirror 13 and output from the first total reflection mirror 13. The light modulator 4R modulates the red light RL incident thereon in accordance with image information input from an image input apparatus that is not shown to form red image light and outputs the red image light. The light modulator 4G is disposed in the optical path of the green light GL reflected off the second dichroic mirror 12 and output from the second dichroic mirror 12. The light modulator 4G modulates the green light GL incident thereon in accordance with image information input from the image input apparatus, which is not shown, to form green image light and outputs the green image light. The light modulator 4B is disposed in the optical path of the blue light BL reflected off the third total reflection mirror 15 and output from the third total reflection mirror 15. The light modulator 4B modulates the blue light BL incident thereon in accordance with image information input from the image input apparatus, which is not shown, to form blue image light and outputs the blue image light. The image input apparatus is, for example, a personal computer or a portable terminal device.

The light modulators 4R, 4G, and 4B are each, for example, a transmissive liquid crystal panel. Polarizers that are not shown are disposed at the light incident and exiting sides of each of the liquid crystal panels. A field lens 10R is disposed in the optical path of the red light RL between the first total reflection mirror 13 and the light modulator 4R. A field lens 10G is disposed in the optical path of the green light GL between the second dichroic mirror 12 and the optical modulator 4G. A field lens 10B is disposed in the optical path of the blue light BL between the third total reflection mirror 15 and the light modulator 4B.

The light combining system 5 is disposed so as to lie on the optical path of the red image light output from the light modulator 4R, the optical path of the green image light output from the light modulator 4G, and the optical path of the blue image light output from the light modulator 4B. In the plan view or the side view as shown in FIG. 1, the position where the light combining system 5 combines the three types of color light with each other coincides with the intersection of the optical path of the red image light, the optical path of the green image light, and the optical path of the blue image light. The light combining system 5 combines the red image light, the green image light, and the blue image light with each other to form color image light. The light combining system 5 outputs the color image light. The light combining system 5 is, for example, a cross dichroic prism.

The projection system 6 is disposed in the optical path of the color image light output from the light combining system 5. The color image light output from the light combining system 5 corresponds to the light modulated by the light modulators 4R, 4G, and 4B. The projection system 6 enlarges the color image light output from the light combining system 5 and entering the projection system 6, and projects the enlarged color image light toward the screen SCR. The color image light enlarged and projected by the projection system 6 is displayed as color video images on a display surface of the screen SCR that faces the light exiting surface of the projection system 6.

The projection system 6 is formed, for example, of a plurality of optical lenses, and may instead be formed of a single optical lens. Examples of the optical lenses may include a variety of lenses, such as a plano-convex lens, a biconvex lens, a meniscus lens, an aspherical lens, a rod lens, and a freeform surface lens.

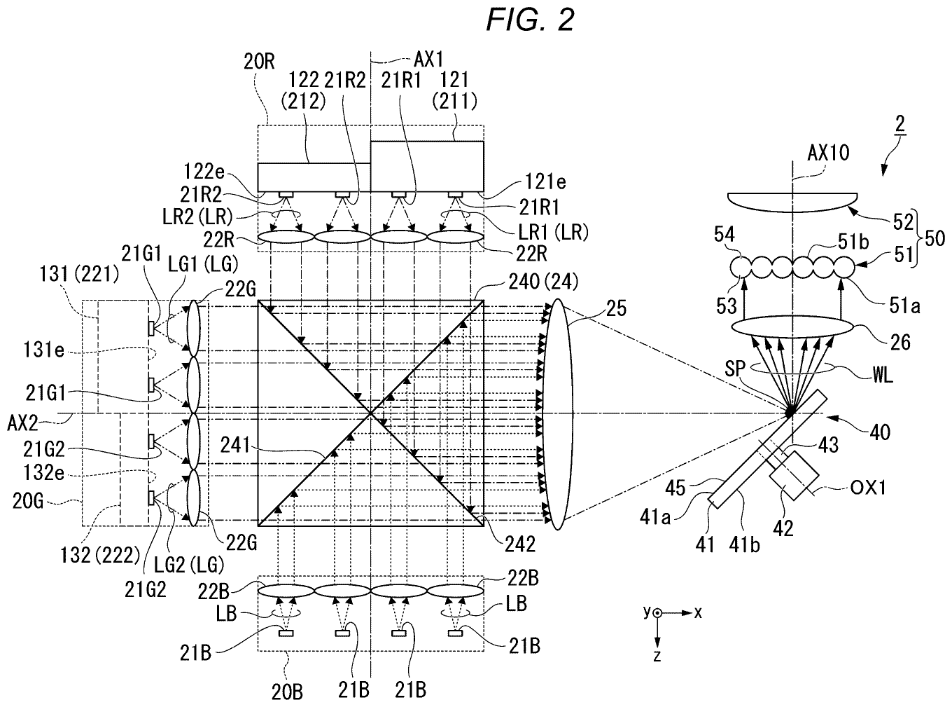

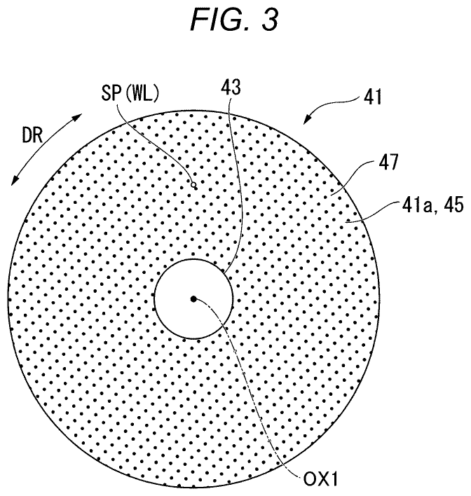

The illuminator 2 according to the first embodiment of the present disclosure will be subsequently described with reference to FIGS. 2 and 3. FIG. 2 is a schematic view showing the configuration of the illuminator 2. The illuminator 2 includes a first light source 20R, a second light source 20G, a third light source 20B, a light combining member 24, a light collector 25, a diffuser 40, a collimator 26, and an optical integration system 50.

The first light source 20R includes first laser devices 21R1, second laser devices 21R2, a first heat dissipation member 211, a second heat dissipation member 212, and first collimation lenses 22R, and outputs red light LR. The red light LR corresponds to first light. The red light LR has a first wavelength band including at least wavelengths that belong to red in the visible wavelength band and a second wavelength band including wavelengths that also belong to red and are longer than the wavelengths in the first wavelength band. Red corresponds to a first color. The red light LR has, for example, a wavelength band ranging from 585 nm to 720 nm.

The first laser devices 21R1 correspond to first light emitters. The first laser devices 21R1 each emit red light LR having a wavelength λR11 at an operating temperature T0. The operating temperature T0 is, for example, 25° C., a temperature within the range around the room temperature, and a symbolic temperature used when the specifications and characteristics of a laser device are described. The wavelength λR11 falls within the first wavelength band of the red light LR.

The first heat dissipation member 211 receives heat from the first laser devices 21R1. That is, the heat of the first laser devices 21R1 is transferred to the first heat dissipation member 211. The first heat dissipation member 211 is, for example, a rectangular-box-shaped heat sink 121 and has two rectangular end surfaces parallel to each other and four side surfaces that couple four sides of one of the two end surfaces to those of the other. The heat sink 121 corresponds to a first heat sink. The two end surfaces of the heat sink 121 are, for example, parallel to an xy plane containing an x direction and a y direction perpendicular to the x direction. Two of the four side surfaces of the heat sink 121 are parallel to an xz plane containing the x direction and a z direction perpendicular to the x and y directions. The other two of the four side surfaces of the heat sink 121 are parallel to a yz plane containing the y and z directions. For example, two first laser devices 21R1 are disposed at an interval in the x direction, and two or more first laser devices 21R1 are disposed at intervals in the y direction at an end surface 121e, which faces the +z direction, out of the two end surfaces of the heat sink 121. The end surface 121e is the surface of the heat sink 121 that faces the light combining member 24.

The light emission surface of each of the first laser devices 21R1 is parallel to the xy plane, and is the surface of the first laser device 21R1 that is opposite from the surface in contact with the end surface 121e of the heat sink 121. The first laser devices 21R1 in light emission operation are heated by a voltage supplied from a power supply that is not shown. At least part of the heat of the first laser devices 21R1 is dissipated via the heat sink 121 adjacent thereto. The first laser devices 21R1 emit red light LR1 having a wavelength λR1 at an operating temperature T1 higher than the operating temperature T0. The wavelength λR1 falls within the first wavelength band of the red light LR and is longer than the wavelength λR11. That is, the wavelength of the red light LR1 emitted by the first laser devices 21R1 increases from the wavelength λR11 to the wavelength λR1 as the operating temperature of the first laser devices 21R1 rises.

The heat sink 121 has a heat dissipation capability of stabilizing the temperatures of the first laser devices 21R1 in light emission operation at the operating temperature T1. The heat sink 121 is sized in each of the x, y, and z directions so as to exhibit the heat dissipation capability of stabilizing the temperatures of the plurality of first laser devices 21R1 in light emission operation at the operating temperature T1. The size of the heat sink 121 in the x direction is, for example, about half the size of the light combining member 24, which will be described later, in the x direction. The size of the heat sink 121 in the y direction is, for example, approximately equal to the size of the light combining member 24 in the y direction.

The first laser devices 21R1 each emit the red light LR1 via the light emission surface radially with the z direction being the center axis of the radial light emission. As an example, the wavelength λR11 of the light from the first laser devices 21R1 at the operating temperature T0 is 638 nm, the operating temperature T1 is 45° C., and the wavelength λR1 at the operating temperature T1 is 640 nm.

The second laser devices 21R2 correspond to second light emitters. The second laser devices 21R2 each emit red light LR having a wavelength λR12 at the operating temperature T0. The wavelength λR12 at least differs from the wavelength λR11 and falls within the second wavelength band of the red light LR. The wavelength λR12 is, for example, longer than the wavelength λR11.

The second heat dissipation member 212 is disposed at a position shifted from the first heat dissipation member 211 in the opposite direction of the x direction, and is disposed so as to overlap with the first heat dissipation member 211 in the z direction. The second heat dissipation member 212 receives heat from the second laser devices 21R2. That is, the heat of the second laser devices 21R2 is transferred to the second heat dissipation member 212.

The second heat dissipation member 212 is, for example, a rectangular-box-shaped heat sink 122 and has two rectangular end surfaces parallel to each other and four side surfaces that couple four sides of one of the two end surfaces to those of the other. The heat sink 122 corresponds to a second heat sink. The two end surfaces of the heat sink 122 are, for example, parallel to the xy plane. Two of the four side surfaces of the heat sink 122 are parallel to the xz plane. The other two of the four side surfaces of the heat sink 122 are parallel to the yz plane. For example, two second laser devices 21R2 are disposed at an interval in the x direction, and two or more second laser devices 21R2 are disposed at intervals in the y direction at an end surface 122e, which faces the +z direction, out of the two end surfaces of the heat sink 122. The end surface 122e is the surface of the heat sink 122 that faces the light combining member 24.

The light emission surface of each of the second laser devices 21R2 is parallel to the xy plane, and is the surface of the second laser device 21R2 that is opposite from the surface in contact with the end surface 122e of the heat sink 122. The second laser devices 21R2 in light emission operation are heated by a voltage supplied from the power supply, which is not shown. At least part of the heat of the second laser devices 21R2 is dissipated via the heat sink 122 adjacent thereto. The second laser devices 21R2 emit red light LR2 having a wavelength λR2 at an operating temperature T2 higher than the operating temperature T1. The wavelength λR2 falls within the second wavelength band of the red light LR and is longer than the wavelengths λR1 and λR12. That is, the wavelength of the red light LR2 emitted by the second laser devices 21R2 increases from the wavelength λR12 to the wavelength λR2 as the operating temperature of the second laser devices 21R2 rises.

The heat sink 122 has a heat dissipation capability of stabilizing the temperatures of the second laser devices 21R2 in light emission operation at the operating temperature T2. The heat sink 122 is sized in each of the x, y, and z directions so as to exhibit the heat dissipation capability of stabilizing the temperatures of the plurality of second laser devices 21R2 in light emission operation at the operating temperature T2.

The heat dissipation capability of the heat sink 122, which is the second heat dissipation member 212, differs from the heat dissipation capability of the heat sink 121, which is the first heat dissipation member 211. For example, since the operating temperature T2 is higher than the operating temperature T1, (T2−T0)>(T1−T0) is satisfied. In this case, the heat dissipation capability of the heat sink 122, which is the second heat dissipation member 212, is smaller than the heat dissipation capability of the heat sink 121, which is the first heat dissipation member 211. Specifically, the sizes of the heat sink 122 in the x and y directions are comparable to the sizes of the heat sink 121 in the x and y directions. The size of the heat sink 122 in the z direction is smaller than the size of the heat sink 121 in the z direction.

The second laser devices 21R2 each emit the red light LR2 via the light emission surface radially with the z direction being the center axis of the radial light emission. As an example, the wavelength λR12 of the light from the second laser devices 21R2 at the operating temperature T0 is 642 nm, the operating temperature T2 is 55° C., and the wavelength λR2 at the operating temperature T2 is 646 nm. As described above, when the wavelength λR11 of the light from the first laser device 21R1 at the operating temperature T0 is 638 nm, and the wavelength λR1 at the operating temperature T1 is 640 nm, the difference in wavelength (λR12−λR11) between the peak wavelength of the light from each of the first laser devices 21R1 in oscillation and the peak wavelength of the light from each of the second laser devices 21R2 in oscillation at the operating temperature T0 is 4 nm. The heat sink 121 is coupled to the first laser devices 21R1, and the heat sink 122 is coupled to the second laser devices 21R2. The difference in wavelength (λR2−λR1) between the red light LR1, which is emitted from the first laser devices 21R1 and has the first wavelength band at the operating temperature T1, and the red light LR2, which is emitted from the second laser devices 21R2 and has the second wavelength band at the operating temperature T2, is therefore 6 nm, which is greater than the difference in wavelength (λR12−λR11).

That is, as the operation of the illuminator 2 continues, the temperatures of the first laser devices 21R1 and the second laser devices 21R2 rise, and the state of the first light source 20R changes from the state in which the first light source 20R outputs the red light LR having the two kinds of wavelengths λR11 and λR12 at the operating temperature T0, which differ from each other in wavelength by 4 nm, to the state in which the first light source 20R outputs the red light LR having the two kinds wavelengths λR1 and λR2, which differ from each other in wavelength by 6 nm. That is, the difference between the two kinds of wavelengths increases.

The number of first collimation lenses 22R is equal to the total number of first laser devices 21R1 and second laser devices 21R2. The first collimation lenses 22R are disposed in the optical path of the red light LR1 emitted from the first laser devices 21R1, and in the optical path of the red light LR2 emitted from the second laser devices 21R2. The center of each of the first collimation lenses 22R in the x direction substantially coincides with the center of the light emission surface of the first laser device 21R1 corresponding to the first collimation lens 22R or the center of the light emission surface of the second laser device 21R2 corresponding thereto.

The first collimation lenses 22R parallelize the red light LR1 and the red light LR2 incident thereon. The red light LR1 and the red light LR2 parallelized by the first collimation lenses 22R travel along the z direction. An optical axis AX1 of the red light LR output from the first light source 20R is parallel to the z direction.

The second light source 20G is disposed at a position shifted from the first light source 20R in the z direction and also shifted from the first light source 20R in the opposite direction of the x direction. The second light source 20G includes first laser devices 21G1, second laser devices 21G2, a first heat dissipation member 221, a second heat dissipation member 222, and second collimation lenses 22G, and emits green light LG. The green light LG corresponds to second light. The green light LG has a first wavelength band including at least wavelengths that belong to green in the visible wavelength band and a second wavelength band including wavelengths that also belong to green and are longer than the wavelengths in the first wavelength band. Green corresponds to a second color and is a color different from red, which is the first color. The green light LG has, for example, a wavelength band ranging from 495 nm to 585 nm.

The first laser devices 21G1 each emit green light LG having a wavelength λG11 at the operating temperature T0. The wavelength λG11 falls within the first wavelength band of the green light LG.

The first heat dissipation member 221 receives heat from the first laser devices 21G1. That is, the heat of the first laser devices 21G1 is transferred to the first heat dissipation member 221. The first heat dissipation member 221 is, for example, a rectangular-box-shaped heat sink 131 and has two rectangular end surfaces parallel to each other and four side surfaces that couple four sides of one of the two end surfaces to those of the other. The two end surfaces of the heat sink 131 are, for example, parallel to the yz plane. Two of the four side surfaces of the heat sink 131 are parallel to the xy plane. The other two of the four side surfaces of the heat sink 131 are parallel to the xz plane. For example, two first laser devices 21G1 are disposed at an interval in the z direction, and two or more first laser devices 21G1 are disposed at intervals in the y direction at an end surface 131e, which faces the +x direction, out of the two end surfaces of the heat sink 131. The end surface at which the two first laser devices 21G1 are provided is the surface of the heat sink 131 that faces the light combining member 24.

The light emission surface of each of the first laser devices 21G1 is parallel to the yz plane. The first laser devices 21G1 in light emission operation are heated by a voltage supplied from the power supply, which is not shown. At least part of the heat of the first laser devices 21G1 is dissipated via the heat sink 131 adjacent thereto. The first laser devices 21G1 emit green light LG1 having a wavelength λG1 at an operating temperature T11 higher than the operating temperature T0. The wavelength λG1 falls within the first wavelength band of the green light LG and is longer than the wavelength λG11. That is, the wavelength of the green light LG1 emitted by the first laser devices 21G1 increases from the wavelength λG11 to the wavelength λG1 as the operating temperature of the first laser devices 21G1 rises.

The heat sink 131 has a heat dissipation capability of stabilizing the temperatures of the first laser devices 21G1 in light emission operation at the operating temperature T11. The heat sink 131 is sized in each of the x, y, and z directions so as to exhibit the heat dissipation capability of stabilizing the temperatures of the plurality of first laser devices 21G1 in light emission operation at the operating temperature T11. The size of the heat sink 131 in the z direction is, for example, approximately half the size of the light combining member 24 in the z direction. The size of the heat sink 131 in the y direction is, for example, comparable to the size of the light combining member 24 in the y direction.

The first laser devices 21G1 each emit the green light LG1 radially with the x direction being the center axis of the radial light emission.

The second laser devices 21G2 each emit the green light LG having a wavelength λG12 at the operating temperature T0. The wavelength λG12 at least differs from the wavelength λG11 and falls within the second wavelength band of the green light LG. The wavelength λG12 is, for example, longer than the wavelength λG11.

The second heat dissipation member 222 is disposed at a position shifted from the first heat dissipation member 221 in the z direction, and is disposed so as to overlap with the first heat dissipation member 221 in the x direction. The second heat dissipation member 222 receives heat from the second laser devices 21G2. That is, the heat of the second laser devices 21G2 is transferred to the second heat dissipation member 222.

The second heat dissipation member 222 is, for example, a rectangular-box-shaped heat sink 132 and has two rectangular end surfaces parallel to each other and four side surfaces that couple four sides of one of the two end surfaces to those of the other. The two end surfaces of the heat sink 132 are, for example, parallel to the yz plane. Two of the four side surfaces of the heat sink 132 are parallel to the xy plane. The other two of the four side surfaces of the heat sink 132 are parallel to the xz plane. For example, two second laser devices 21G2 are disposed at an interval in the z direction, and two or more second laser devices 21G2 are disposed at intervals in the y direction at an end surface 132e, which faces the +x direction, out of the two end surfaces of the heat sink 132. The end surface at which the two second laser devices 21G2 are provided is the surface of the heat sink 132 that faces the light combining member 24.

The light emission surface of each of the second laser devices 21G2 is parallel to the yz plane. The second laser devices 21G2 in light emission operation are heated by a voltage supplied from the power supply, which is not shown. At least part of the heat of the second laser devices 21G2 is dissipated via the heat sink 132 adjacent thereto. The second laser devices 21G2 emit green light LG2 having a wavelength λG2 at an operating temperature T12 higher than the operating temperature T11. The wavelength λG2 falls within the second wavelength band of the green light LG and is longer than the wavelengths λG1 and λG12. That is, the wavelength of the green light LG2 emitted by the second laser devices 21G2 increases from the wavelength λG12 to the wavelength λG2 as the operating temperature of the second laser devices 21G2 rises. The heat sink 132 has a heat dissipation capability of stabilizing the temperatures of the second laser devices 21G2 in light emission operation at the operating temperature T12. The heat sink 132 is sized in each of the x, y, and z directions so as to exhibit the heat dissipation capability of stabilizing the temperatures of the plurality of second laser devices 21G2 in light emission operation at the operating temperature T12.

The heat dissipation capability of the heat sink 132, which is the second heat dissipation member 222, differs from the heat dissipation capability of the heat sink 131, which is the first heat dissipation member 221. For example, since the operating temperature T12 is higher than the operating temperature T11, (T12−T0)>(T11−T0) is satisfied. In this case, the heat dissipation capability of the heat sink 132, which is the second heat dissipation member 222, is smaller than the heat dissipation capability of the heat sink 131, which is the first heat dissipation member 221. Specifically, the sizes of the heat sink 132 in the y and z directions are comparable to the sizes of the heat sink 131 in the y and z directions. The size of the heat sink 132 in the x direction is smaller than the size of the heat sink 131 in the x direction.

The second laser devices 21G2 each emit the green light LG2 via the light emission surface radially with the x direction being the center axis of the radial light emission. The heat sink 131 is coupled to the first laser devices 21G1, and the heat sink 132 is coupled to the second laser devices 21G2. The difference in wavelength (λG2−λG1) between the green light LG1, which is emitted from the first laser devices 21G1 and has the first wavelength band at the operating temperature T11, and the green light LG2, which is emitted from the second laser devices 21G2 and has the second wavelength band at the operating temperature T12, is therefore greater than the difference in wavelength (λG12−λG11) between the peak wavelength of the light from each of the first laser devices 21G1 in oscillation and the peak wavelength of the light from each of the second laser devices 21G2 in oscillation at the operating temperature T0.

That is, as the operation of the illuminator 2 continues, the temperatures of the first laser devices 21G1 and the second laser devices 21G2 rise, and the state of the second light source 20G also changes from the state in which the second light source 20G outputs the green light LG having the two kinds of wavelengths λG11 and λG12 at the operating temperature T0 to the state in which the second light source 20G outputs the green light LG having the two kinds wavelengths λG1 and λG2. That is, the difference between the two kinds of wavelengths increases.

The number of second collimation lenses 22G is equal to the total number of first laser devices 21G1 and second laser devices 21G2. The second collimation lenses 22G are disposed in the optical path of the green light LG1 emitted from the first laser devices 21G1, and in the optical path of the green light LG2 emitted from the second laser devices 21G2. The center of each of the second collimation lenses 22G in the z direction substantially coincides with the center of the light emission surface of the first laser device 21G1 corresponding to the second collimation lens 22G or the center of the light emission surface of the second laser device 21G2 corresponding thereto.

The second collimation lenses 22G parallelize the green light LG1 and the green light LG2 incident thereon. The green light LG1 and the green light LG2 parallelized by the second collimation lenses 22G travel along the x direction. An optical axis AX2 of the green light LG output from the second light source 20G is parallel to the x direction.

The third light source 20B is disposed at a position shifted from the second light source 20G in the z direction, and is disposed so as to coincide with the first light source 20R in the x direction. The third light source 20B includes laser devices 21B and collimation lenses 22B, and outputs blue light LB. The blue light LB has a wavelength band including wavelengths that belong at least to blue in the visible wavelength band. Blue is a color different from red, which is the first color, and green, which is the second color. The blue light LB has, for example, a wavelength band ranging from 380 nm to 495 nm.

The third light source 20B includes, for example, four laser devices 21B. The four laser devices 21B are disposed at intervals in the x direction. The light emission surface of each of the laser devices 21B is parallel to the xy plane. The laser devices 21B each emit the blue light LB radially with the z direction being the center axis of the radial light emission and in the opposite direction of the z direction.

The number of collimation lenses 22B is equal to the total number of laser devices 21B. The collimation lenses 22B are disposed in the optical path of the blue light LB emitted from the laser devices 21B. The center of each of the collimation lenses 22B in the x direction substantially coincides with the center of the light emission surface of the laser device 21B corresponding to the collimation lens 22B.

The collimation lenses 22B parallelize the blue light LB incident thereon. The blue light LB parallelized by the collimation lenses 22B travel along the opposite direction of the z direction. The optical axis AX1 of the blue light LB output from the third light source 20B is parallel to the z direction.

The optical axis AX1 of the blue light LB and the optical axis AX1 of the red light LR form the same line, and the optical axis AX1 of the blue light LB is the extension of the optical axis AX1 of the red light LR extended toward the light combining member 24 so as to pass through the position where the light combining member 24 combines the three types of color light with each other, and further extended toward the side opposite from the first light source 20R with respect to the light combining member 24.

Note that the first light source 20R, the second light source 20G, and the third light source 20B may each include a member other than the laser devices, the collimation lenses, and the variety of heat dissipation members, such as packages that hold the laser devices and the collimation lenses.

The light combining member 24 is disposed so as to lie on the optical path of the red light LR output from the first light source 20R, the optical path of the green light LG output from the second light source 20G, and the optical path of the blue light LB output from the third light source 20B. In the plan view or the side view as shown in FIG. 2, the position where the light combining member 24 combines the three types of color light with each other coincides with the intersection of the optical path of the red light LR, the optical path of the green light LG, and the optical path of the blue light LB, that is, the intersection of the optical axis AX1 and the optical axis AX2.

The light combining member 24 combines the incident red light LR, green light LG, and blue light LB with each other to generate the white light WL. The white light WL corresponds to combined light. The light combining member 24 outputs the white light WL along the optical axis AX2. The optical axis AX2 of the white light WL and the optical axis AX2 of the green light LG form the same line. The optical axis AX2 of the white light WL is an extension of the optical axis AX2 of the green light LG extended toward the light combining member 24 so as to pass through the position where the light combining member 24 combines the three types of color light with each other, and further extended toward the side opposite from the second light source 20G with respect to the light combining member 24.

The light combining member 24 is, for example, a cross dichroic prism 240. The cross dichroic prism 240 includes a first dichroic mirror 241 and a second dichroic mirror 242. In the plan view or the side view in which the optical axes AX1 and AX2 are perpendicular to each other, the reflection surface of the first dichroic mirror 241 and the reflection surface of the second dichroic mirror 242 each incline with respect to the optical axes AX1 and AX2. In the plan view or the side view, the angle between the reflection surface of each of the first dichroic mirror 241 and the second dichroic mirror 242 and each of the optical axes AX1 and AX2 is 45°. In the plan view or the side view in which the optical axes AX1 and AX2 are perpendicular to each other, the reflection surface of the first dichroic mirror 241 and the reflection surface of the second dichroic mirror 242 are perpendicular to each other.

The first dichroic mirror 241 reflects the blue light LB and transmits the green light LG and the red light LR. The second dichroic mirror 242 reflects the red light LR and transmits the blue light LB and the green light LG. The red light LR output from the first light source 20R is incident on the second dichroic mirror 242 along the optical axis AX1, is reflected off the second dichroic mirror 242, is output along the optical axis AX2 toward the side opposite from the second light source 20G, and passes through the first dichroic mirror 241. The green light LG output from the second light source 20G is incident on the first dichroic mirror 241 along the optical axis AX2, travels straight, and passes through the first dichroic mirror 241 and the second dichroic mirror 242. The blue light LB output from the third light source 20B is incident on the first dichroic mirror 241 along the optical axis AX1, is reflected off the first dichroic mirror 241, is output along the optical axis AX2 toward the side opposite from the second light source 20G, and passes through the second dichroic mirror 242.

The red light RL, the green light LG, and the blue light LB output from the first dichroic mirror 241 and the second dichroic mirror 242 are combined with each other to generate the white light WL, as described above. The white light WL is output along the optical axis AX2 via the side surface of the cross dichroic prism 240 that is opposite from the side surface facing the second light source 20G.

The light collector 25 is disposed in the optical path of the white light WL between the light combining member 24 and the diffuser 40. The light collector 25 collects the parallelized white light WL output from the light combining member 24 and outputs the collected white light WL toward the diffuser 40. The center of the light collector 25 in the direction perpendicular to the optical axis AX2 substantially coincides with the optical axis AX2. The light collector 25 is, for example, a biconvex lens, and may instead be an optical element having a light collecting function other than a biconvex lens, or a plano-convex lens, or may still instead be formed of a plurality of optical lenses.

The diffuser 40 is disposed in the optical path of the white light WL output from the light collector 25. The diffuser 40 diffuses the white light WL collected by the light collector 25 and incident on the diffuser 40, and outputs the diffused white light WL. The diffuser 40 is, for example, a reflective diffuser, and diffusively reflects the white light WL incident thereon.

The diffuser 40 includes, for example, a substrate 41 and a driver 42. The substrate 41 has a light incident surface 41a, which is irradiated with the white light WL collected by the light collector 25 and at which a collected light spot SP of the white light WL is therefore formed, and a rear surface 41b opposite from the light incident surface 41a. The substrate 41 is disposed with the light incident surface 41a facing the light collector 25. In the plan view or the side view in which the optical axes AX1 and AX2 are perpendicular to each other, the angle between the light incident surface 41a and the optical axis AX2 is 45°.

The substrate 41 is attached to the driver 42 so as to be rotatable around an axis of rotation OX1. The driver 42 rotates the substrate 41 around the axis of rotation OX1. The driver 42 is, for example, a motor, and includes a shaft member 43 having a center axis that coincides with the axis of rotation OX1. For example, the shaft member 43 is inserted into a central portion of the substrate 41 from the side facing the rear surface 41b. The centers of the light incident surface 41a and the rear surface 41b of the substrate 41 coincide with the axis of rotation OX1. The substrate 41 rotates around the axis of rotation OX1 as described above in conjunction with the rotation of the shaft member 43 around the axis of rotation OX1, and diffuses the white light WL. The driver 42 is not limited to a motor and only needs to be an apparatus capable of rotating the substrate 41 as described above.

FIG. 3 is a schematic view of the substrate 41 of the diffuser 40 viewed from the side facing the light incident surface 41a along the axis of rotation OX1. When viewed along the axis of rotation OX1, the collected light spot SP of the white light WL is formed at the light incident surface 41a of the substrate 41 in a region between the radial center of the light incident surface 41a, that is, the axis of rotation OX1, and the circumferential end thereof, as shown in FIGS. 2 and 3. The light incident surface 41a constitutes a diffusion surface 45, which diffuses the white light WL incident thereon and outputs the diffused white light WL. A protruding and recessed structure 47 is formed at the light incident surface 41a. The protruding and recessed structure 47 is designed as appropriate in consideration of the wavelength band of the white light WL so as to appropriately diffuse the white light WL, and is formed the same as a protruding and recessed structure formed at a known diffusion plate. The protruding and recessed structure 47 may be formed, for example, by blasting, or may be realized by forming a plurality of microlenses each having a diameter smaller than or equal to the wavelengths of the white light WL by using the optical lithography technology. The protruding and recessed structure 47 may be formed, for example, by dispersing a plurality of particles each having an appropriate particle diameter on the base of the substrate 41 and covering the plurality of particles with resin in such a way that the resin reflects the shape of the surface formed by the plurality of particles. The protruding and recessed structure 47 may be formed across the entire range in the radial direction from the center of the light incident surface 41a to the circumferential end thereof as shown in FIG. 3, or may instead be formed in a smaller range in the radial direction including at least the region irradiated with the collected light spot SP.

When the substrate 41 is made of a material that transmits the white light WL, such as optical glass and plastic, a reflection film that is not shown is, for example, provided at the surface of the protruding and recessed structure 47. When the substrate 41 is made of a material that reflects the white light WL, such as metal, a reflection film that is not shown may not be provided at the surface of the protruding and recessed structure 47. Providing a reflection film, however, improves the reflection characteristics of the light incident surface 41a. In FIG. 3, the protruding and recessed structure 47 is shown by dots by way of example. The protruding and recessed structure 47 is made of a material that does not block but transmits the white light WL, as the substrate 41 is.

The white light WL is diffusively reflected off the diffusion surface 45. The diffused white light WL is a mixture of the red light LR1 having the first wavelength band of the red light LR and the red light LR2 having the second wavelength band of the red light LR contained in the white light WL, the green light LG1 having the first wavelength band of the green light LG and the green light LG2 having the second wavelength band of the green light LG contained in the white light WL, and the blue light LB contained in the white light WL. The red light LR1 and the red light LR2, the green light LG1 and the green light LG2, and the blue light LB are distributed in a substantially uniform manner along a surface that intersects with the optical axis AX2 of the collected light spot SP of the white light WL and with an optical axis AX10. When the substrate 41 of the diffuser 40 rotates in a rotational direction DR around the axis of rotation OX1, the speckle pattern of the white light WL in the collected light spot SP changes.

The white light WL is diffusively reflected off the diffusion surface 45, and output from the collected light spot SP along the optical axis AX10 as diffused light having a diffusion, scattering, or diffraction pattern produced by the protruding and recessed structure 47. The optical axis AX10 passes through the center of a region of the light incident surface 41a of the substrate 41 that is the region irradiated with the collected light spot SP, and is parallel to the optical axis AX1.

The collimator 26 is disposed in the optical path of the white light WL output from the substrate 41 of the diffuser 40. The collimator 26 parallelizes the diffusively diverging white light WL output from the light incident surface 41a and the diffusion surface 45 of the substrate 41. The center of the collimator 26 in the direction perpendicular to the optical axis AX10 substantially coincides with the optical axis AX10. The collimator 26 is, for example, a biconvex lens, and may instead be an optical element having a light collecting function other than a biconvex lens, or a plano-convex lens, or may still instead be formed of a plurality of optical lenses. When the collimator 26 is formed by a single optical lens, using an aspherical lens allows further improvement in the accuracy of the collimation.

The optical integration system 50 includes a multi-lens array 51 and a superimposing lens 52. The optical integration system 50 homogenizes the illuminance distribution of the white light WL output from the collimator 26 in an image formation region of each of the light modulators 4R, 4G, and 4B disposed downstream from the optical integration system 50.

The multi-lens array 51 is disposed in the optical path of the parallelized white light WL output from the collimator 26. The multi-lens array 51 is, for example, a double-sided multi-lens array or includes multi-lens arrays at opposite sides. The double-sided multi-lens array includes a plurality of microlenses 53, which divide the white light WL output from the collimator 26 into a plurality of thin luminous fluxes. The plurality of microlenses 53 are adjacent to each other along a plane perpendicular to the optical axis AX10 and are arranged in a matrix. The microlenses 53 are each, for example, a plano-convex lens having a convex surface at the light incident side. The double-sided multi-lens array has a first multi-lens surface 51a provided at the light incident side along the shape of the plano-convex lenses, which constitute the microlenses 53. The double-sided multi-lens array further includes a plurality of microlenses 54, the number of which is equal to the number of microlenses 53, in a plane perpendicular to the optical axis AX10. The microlenses 54 are adjacent to each other along a plane perpendicular to the optical axis AX10, are arranged in a matrix, and correspond to the microlenses 53. The microlenses 54 are each, for example, a plano-convex lens having a convex surface at the light exiting side. The light-exiting-side surface of each of the plurality of microlenses 54 has a shape that is the same as the shape of the light-incident-side surface of the corresponding one of the plurality of microlenses 53. The double-sided multi-lens array has a second multi-lens surface 51b provided at the light exiting side along the shape of the plano-convex lenses, which constitute the microlenses 54.

The superimposing lens 52 collects each of the plurality of thin luminous fluxes of the white light WL output from the multi-lens array 51, and cooperates with the plurality of microlenses 54 of the multi-lens array 51 to superimpose the thin luminous fluxes with each other in the image formation region of each of the light modulators 4R, 4G, and 4B or in the vicinity of the image formation region. The superimposing lens 52 is, for example, a plano-convex lens, and may instead be an optical element having a light collecting function other than a plano-convex lens, or a biconvex lens, or may still instead be formed of a plurality of optical lenses.

The illuminator 2 according to the first embodiment described above includes the first light source 20R, the second light source 20G, the light combining member 24, the diffuser 40, the light collector 25, and the collimator 26. The first light source 20R outputs the red light (first light having first color) LR. The second light source 20G outputs the green light (second light having color different from first color) LG. The light combining member 24 combines the red light LR and the green light LG with each other and outputs the white light (combined light) WL. The diffuser 40 includes the substrate 41 having the diffusion surface 45, which diffuses the white light WL incident thereon and outputs the diffused white light WL, and the driver 42, which rotates the substrate 41. The light collector 25 is disposed between the light combining member 24 and the diffuser 40, collects the white light WL, and causes the collected white light WL to be incident on the diffusion surface 45 of the substrate 41 of the diffuser 40. The collimator 26 parallelizes the white light WL output from the substrate 41 of the diffuser 40. The first light source 20R includes the plurality of first laser devices (first light emitters) 21R1, the plurality of second laser devices (second light emitters) 21R2, the first heat dissipation member 211, and the second heat dissipation member 212. The heat of the plurality of first laser devices 21R1 is transferred to the first heat dissipation member 211. The heat of the plurality of second laser devices 21R2 is transferred to the second heat dissipation member 212. The first laser devices 21R1 each emit the red light LR1 having the first wavelength band. The second laser devices 21R2 each emit the red light LR2 having the second wavelength band different from the first wavelength band. The heat dissipation capability of the first heat dissipation member 211 and the heat dissipation capability of the second heat dissipation member 212 differ from each other.

In contrast to the illuminator 2 according to the first embodiment, as the configuration of an illuminator of related art, a configuration in which the first light source 20R includes only the first laser devices 21R1 may be presented. In the illuminator 2 according to the first embodiment, the first light source 20R includes the second laser devices 21R2, which each emit the red light LR2, in addition to the first laser devices 21R1, which each emit the red light LR1. The illuminator 2 according to the first embodiment creates the difference in wavelength (λR12−λR11) associated with the red light LR contained in the white light WL diffused by the diffuser 40 and entering the optical integration system 50, as compared with the illuminator of related art, which does not include the second laser devices 21R2, so that speckle noise produced by the white light WL is reduced. The illuminator 2 according to the first embodiment can favorably reduce the speckle noise that appears in a projection image when the white light WL output from the illuminator 2 is projected.

Another illuminator of related art different from the illuminator of related art described above may have a configuration in which the first light source 20R includes the first laser devices 21R1 and the second laser devices 21R2 but does not include the first heat dissipation member 211 or the second heat dissipation member 212, or a configuration in which the first heat dissipation member 211 and the second heat dissipation member 212 have the same heat dissipation capability. In the illuminator 2 according to the first embodiment, the heat dissipation via the first heat dissipation member 211 allows the first laser devices 21R1 to each emit the red light LR1 at the operating temperature T1 higher than the reference operating temperature T0, and the heat dissipation via the second heat dissipation member 212 allows the second laser devices 21R2 to each emit the red light LR2 at the operating temperature T2 different from the operating temperatures TO and T1. Therefore, in the illuminator 2 according to the first embodiment, appropriately setting the heat dissipation capability of each of the first heat dissipation member 211 and the second heat dissipation member 212 causes the difference in wavelength (λR2−λR1) associated with the red light LR contained in the white light WL diffused by the diffuser 40 and entering the optical integration system 50 to be greater than the difference in wavelength (λR12−λR11), as compared with the illuminator of related art that does not include the first heat dissipation member 211 or the second heat dissipation member 212, and the configuration in which the heat dissipation members have the same heat dissipation capability, so that speckle noise produced by the white light WL is favorably reduced. In the illuminator 2 according to the first embodiment, when the white light WL output from the illuminator 2 is projected, speckle noise that appears in a projection image can be reduced favorably and effectively.

In the illuminator of related art that does not include the first heat dissipation member 211 or the second heat dissipation member 212, and in the configuration in which the heat dissipation members have the same heat dissipation capability, to increase the difference in wavelength (λR12−λR11), it is conceivable to take a measure of providing in advance first laser devices 21R1 that each emit the red light LR1 having a red wavelength comparable to the wavelength λR1 at the operating temperature T0, and second laser devices 21R2 that each emit the red light LR2 having a red wavelength comparable to the wavelength λR2 at the operating temperature T0. The measure described above, however, requires to manufacture many types of first laser devices 21R1 and second laser devices 21R2 to realize a desired difference in wavelength (λR2−λR1) associated with the red light LR, resulting in an enormous number of manufacturing processes and an enormous amounts of workloads and costs as compared with the case where the heat dissipation capability of the first heat dissipation member 211 and the heat dissipation capability of the second heat dissipation member 212 are adjusted. The illuminator 2 according to the first embodiment can readily reduce the speckle noise that appears in the white light WL output from the illuminator 2 and a projection image in an inexpensive manner. Furthermore, the illuminator 2 according to the first embodiment, which does not need to use the second laser devices 21R2 that each emit the red light LR2 having an excessively long wavelength, can prevent early degradation of the performance of the second laser devices 21R2 in the illuminator 2.

In the illuminator 2 according to the first embodiment, the wavelengths in the first wavelength band are shorter than those in the second wavelength band. The heat dissipation capability of the first heat dissipation member 211 is greater than the heat dissipation capability of the second heat dissipation member 212.

In the illuminator 2 according to the first embodiment, the heat dissipation via the first heat dissipation member 211 allows the first laser devices 21R1 to each emit the red light LR1 at the operating temperature T1, and the heat dissipation via the second heat dissipation member 212 allows the second laser devices 21R2 to each emit the red light LR2 at the operating temperature T2 higher than the operating temperature T1. As a result, the difference in wavelength (λR2−λR1) associated with the red light LR contained in the white light WL that enters the optical integration system 50 becomes greater than the difference in wavelength (λR12−λR11), so that the speckle noise produced by the white light WL is favorably reduced. In the illuminator 2 according to the first embodiment, when the white light WL output from the illuminator 2 is projected, speckle noise that appears in a projection image can be reduced favorably and effectively.

In the illuminator 2 according to the first embodiment, the first heat dissipation member 211 may include a heat sink (first heat sink) 121 including a plurality of first fins. The second heat dissipation member 212 may include a heat sink (second heat sink) 122 including a plurality of second fins. In the illuminator 2 according to the first embodiment, the heat sink 121 is larger than the heat sink 122.

Although not shown in FIG. 2, in the illuminator 2 according to the first embodiment, a plurality of first fins may be provided at an end surface or a side surface the heat sink 121, which constitutes the first heat dissipation member 211, other than the end surface 121e. The size of the first fins and the number thereof are so set that providing the plurality of first fins causes the heat sink 121 to exhibit the heat dissipation capability of stabilizing the temperature of the first laser devices 21R1 in light emission operation at the operating temperature T1. Similarly, a plurality of second fins may be provided at an end surface or a side surface of the heat sink 122, which constitutes the second heat dissipation member 212, other than the end surface 122e. The size of the second fins and the number thereof are so set that providing the plurality of second fins causes the heat sink 122 to exhibit the heat dissipation capability of stabilizing the temperature of the second laser devices 21R2 in light emission operation at the operating temperature T2. In the configuration described above, the heat dissipation capability of the heat sink 121 is greater than the heat dissipation capability of the heat sink 122. In the illuminator 2 according to the first embodiment, the difference in wavelength (λR2−λR1) associated with the red light LR contained in the white light WL that enters the optical integration system 50 is greater than the difference in wavelength (λR12−λR11), so that the speckle noise produced by the white light WL can be favorably reduced.

In the illuminator 2 according to the first embodiment, the number of first fins may be greater than the number of second fins. In the configuration described above, the heat dissipation capability of the heat sink 121 is greater than the heat dissipation capability of the heat sink 122, as in the case where the heat sink 121 is larger than the heat sink 122. Therefore, in the illuminator 2 according to the first embodiment, the difference in wavelength (λR2−λR1) associated with the red light LR contained in the white light WL that enters the optical integration system 50 is greater than the difference in wavelength (λR12−λR11), so that the speckle noise produced by the white light WL can be favorably reduced.

Although not shown in FIG. 2, the first heat dissipation member 211 may include the heat sink 121 including a plurality of first fins and a third heat sink including a plurality of third fins. The second heat dissipation member 212 may include the heat sink 122 including a plurality of second fins. The heat sink 121 and the third heat sink may be coupled to each other via a heat transport member. Examples of the heat transport member may include a heat pipe.

In the illuminator 2 according to the first embodiment, since the third heat sink is thermally coupled to the heat sink 121 via the heat transport member, the operating temperature T1 can be readily adjusted by the heat dissipation capability of the third heat sink as compared with the case where only the heat sink 121 is coupled to the first laser devices 21R1. The number of heat sinks or heat dissipation members other than heat sinks coupled to at least one of the heat sink 121, which constitutes the first heat dissipation member 211, and the heat sink 122, which constitutes the second heat dissipation member 212 is not limited to a specific number, and is appropriately set in accordance with a desired operating temperature T1.

The number of first laser devices 21R1 and the number of second laser devices 21R2 provided in the first light source 20R are each not limited to two, and are appropriately set in consideration of the amount of the red light LR required for the illuminator 2, the amount of light emitted from the first laser devices 21R1, and the amount of light emitted from the second laser devices 21R2. Similarly, the number of first laser devices 21G1 and the number of second laser devices 21G2 provided in the second light source 20G are each not limited to two, and are appropriately set in consideration of the amount of the green light LG required for the illuminator 2, the amount of light emitted from the first laser devices 21G1, and the amount of light emitted from the second laser devices 21G2. The number of laser devices 21B provided in the third light source 20B is not limited to four, and is appropriately set in consideration of the amount of the blue light LB required for the illuminator 2 and the amount of light emitted from the laser devices 21B.

The set of the two first laser devices 21R1 and the heat sink 121 and the set of the two second laser devices 21R2 and the heat sink 122 may be swapped in the x direction.

In the illuminator 2 according to the first embodiment, the first light is red.

The speckle noise produced by the red light LR out of the three primary colors contained in the white light WL is likely to be apparent. In the illuminator 2 according to the first embodiment, the difference in wavelength (λR2−λR1) associated with the red light LR contained in the white light WL that enters the optical integration system 50 is greater than the difference in wavelength (λR12−λR11), so that the speckle noise produced by the red light LR contained in the white light WL can be favorably reduced.

In the illuminator 2 according to the first embodiment, for example, two first laser devices 21R1 are disposed at an interval in the x direction, and two or more first laser devices 21R1 are disposed at intervals in the y direction at the end surface facing the +z direction out of two end surfaces of the heat sink 121, as described above. In the illuminator 2 according to the first embodiment, the number of first laser devices 21R1 in the x direction and the number thereof in the y direction at the end surface 121e of the heat sink 121 may be changed and are appropriately set. Similarly, the number of second laser devices 21R2 in the x direction and the number thereof in the y direction at the end surface 122e of the heat sink 122 may be changed and are appropriately set. In the illuminator 2 according to the first embodiment, the number of first laser devices 21G1 in the z direction and the number thereof in the y direction at the end surface 131e of the heat sink 131 may be changed and are appropriately set. Similarly, the number of second laser devices 21G2 in the z direction and the number thereof in the y direction at the end surface 132e of the heat sink 132 may be changed and are appropriately set.

In the illuminator 2 according to the first embodiment, it is believed that the blue light LB out of the three primary colors contained in the white light WL is sufficiently diffused by the diffuser 40, so that speckle noise caused by the blue light LB is hardly apparent. The third light source 20B therefore does not include a heat dissipation member. On the other hand, the speckle noise produced by the red light LR and the green light LG out of the three primary colors contained in the white light WL is likely to be apparent. The first light source 20R and the second light source 20G therefore include the heat dissipation members coupled to the respective laser devices as described above. However, in a case where speckle noise produced by the green light LG is not apparent even when the first heat dissipation member 221 and the second heat dissipation member 222 are not coupled to the first laser devices 21G1 and the second laser devices 21G2, respectively, the first heat dissipation member 221 and the second heat dissipation member 222 may be omitted in the second light source 20G.

The projector 1 according to the first embodiment includes the illuminator 2 described above, the light modulators 4R, 4G, and 4B, and the projection system 6. The light modulator 4R modulates the red light RL contained in the white light WL output from the illuminator 2 to generate the red image light. The light modulator 4G modulates the green light GL contained in the white light WL to generate the green image light. The light modulator 4B modulates the blue light BL contained in the white light WL to generate the blue image light. The projection system 6 projects the image light modulated by the light modulators 4R, 4G, and 4B.

In the projector 1 according to the first embodiment, the pattern of diffusion, scattering, or diffraction and the speckle pattern of the white light WL output from the illuminator 2 change temporally and effectively, so that the speckle noise is reduced. The projector 1 according to the first embodiment can favorably reduce speckle noise that appears in a projection image when the white light WL output t from the illuminator 2 is converted into the image light by the light modulators 4R, 4G, and 4B and the image light is projected onto the screen SCR.

### Second Embodiment

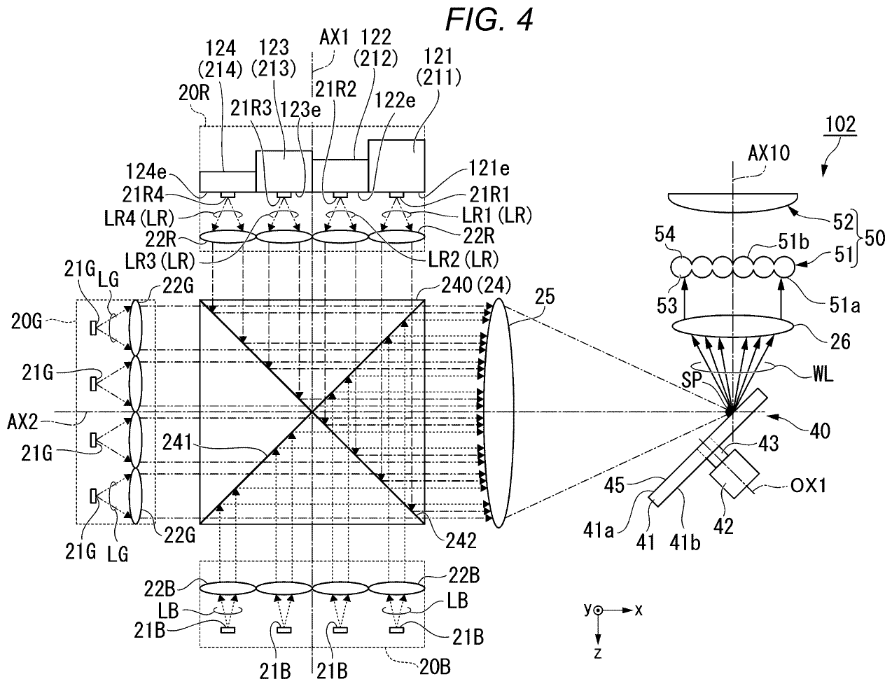

An illuminator 102 according to a second embodiment of the present disclosure will be subsequently described with reference to FIG. 4. In the description of the second embodiment, the contents common to those in the first embodiment are omitted, and configurations and contents different from those already described in the first embodiment are described.

Although not shown, the projector according to the second embodiment includes the illuminator 102 described below in place of the illuminator 2 in the projector 1 according to the first embodiment.

FIG. 4 is a schematic view showing the illuminator 102. The illuminator 102 includes the first light source 20R, the second light source 20G, the third light source 20B, the light combining member 24, the light collector 25, the diffuser 40, the collimator 26, and the optical integration system 50.

The first light source 20R includes the plurality of first laser devices 21R1, the plurality of second laser devices 21R2, a plurality of third laser devices 21R3, a plurality of fourth laser devices 21R4, the first heat dissipation member 211, the second heat dissipation member 212, a third heat dissipation member 213, a fourth heat dissipation member 214, and the first collimation lenses 22R, and outputs the red light LR. The third laser devices 21R3 correspond to third light emitters. The fourth laser devices 21R4 correspond to fourth light emitters. The red light LR has the first wavelength band, the second wavelength band, a third wavelength band including at least wavelengths that belong to red in the visible wavelength band, and a fourth wavelength band including at least wavelengths that belong to red. The wavelengths in the third wavelength band are longer than those in the second wavelength band. The wavelengths in the fourth wavelength band are longer than those in the third wavelength band.

In the first light source 20R of the illuminator 102, one first laser device 21R1 is disposed, and two or more first laser devices 21R1 are disposed at intervals in the y direction at the end surface 121e of the heat sink 121. One second laser device 21R2 is disposed, and two or more second laser devices 21R2 are disposed at intervals in the y direction at the end surface 122e of the heat sink 122. In the illuminator 102, the wavelength λR12 is equal to the wavelength λR11. That is, the second laser devices 21R2 each emit the red light LR having the wavelength λR11 at the operating temperature T0. The size of each of the heat sinks 121 and 122 in the x direction is, for example, about a quarter the size of the light combining member 24 in the x direction.

The third laser devices 21R3 correspond to third light emitters. The third laser devices 21R3 each emit the red light LR having a wavelength λR13 at the operating temperature T0. The wavelength λR13 falls within the third wavelength band of the red light LR. The wavelength λR13 is, for example, longer than the wavelength λR11.

The third heat dissipation member 213 is disposed at a position shifted from the second heat dissipation member 212 in the opposite direction of the x direction, and is disposed so as to overlaps with the first heat dissipation member 211 in the z direction. The third heat dissipation member 213 receives heat from the third laser devices 21R3. That is, the heat of the third laser devices 21R3 is transferred to the third heat dissipation member 213.

The third heat dissipation member 213 is, for example, a rectangular-box-shaped heat sink 123 and has two rectangular end surfaces parallel to each other and four side surfaces that couple four sides of one of the two end surfaces to those of the other. The two end surfaces of the heat sink 123 are, for example, parallel to the xy plane. Two of the four side surfaces of the heat sink 123 are parallel to the xz plane. The other two of the four side surfaces of the heat sink 123 are parallel to the yz plane. For example, one third laser device 21R3 is disposed in the x direction, and two or more third laser devices 21R3 are disposed at intervals in the y direction at an end surface 123e, which faces the +z direction, out of the two end surfaces of the heat sink 123. The end surface 123e is the surface of the heat sink 123 that faces the light combining member 24.

The light emission surface of each of the third laser devices 21R3 is parallel to the xy plane, and is the surface of the third laser device 21R3 that is opposite from the surface in contact with the end surface 123e of the heat sink 123. The third laser devices 21R3 in light emission operation are heated by a voltage supplied from the power supply, which is not shown. At least part of the heat of the third laser devices 21R3 is dissipated via the heat sink 123 adjacent thereto. The third laser devices 21R3 emit red light LR3 having a wavelength λR3 at an operating temperature T3 lower than the operating temperature T2. The wavelength λR3 falls within the third wavelength band of the red light LR and is longer than the wavelengths λR1, λR2, and λR13. That is, the wavelength of the red light LR3 emitted by the third laser devices 21R3 increases from the wavelength λR13 to the wavelength λR3 as the operating temperature of the third laser devices 21R3 rises. The heat sink 123 has a heat dissipation capability of stabilizing the temperature of the third laser devices 21R3 in light emission operation at the operating temperature T3. The heat sink 123 is sized in each of the x, y, and z directions so as to exhibit the heat dissipation capability of stabilizing the temperatures of the plurality of third laser devices 21R3 in light emission operation at the operating temperature T3.

The heat dissipation capability of the heat sink 123, which is the third heat dissipation member 213, differs from the heat dissipation capability of each of the heat sinks 121 and 122. For example, since the operating temperature T3 is higher than the operating temperature T1 but lower than the operating temperature T2, (T2−T0)>(T3−T0)>(T1−T0) is satisfied. In this case, the heat dissipation capability of the heat sink 123 is smaller than the heat dissipation capability of the heat sink 121 but greater than the heat dissipation capability of the heat sink 122. Specifically, the sizes of the heat sink 123 in the x and y directions are comparable to the sizes of the heat sinks 121 and 122 in the x and y directions. The size of the heat sink 123 in the z direction is smaller than the size of the heat sink 121 in the z direction but greater than the size of the heat sink 122 in the z direction.

The fourth laser devices 21R4 correspond to fourth light emitters. The fourth laser devices 21R4 each emit the red light LR having a wavelength λR14 at the operating temperature T0. In the illuminator 102, the wavelength λR14 is equal to the wavelength λR13. That is, the fourth laser devices 21R4 each emit the red light LR having the wavelength λR13 at the operating temperature T0.

The fourth heat dissipation member 214 is disposed at a position shifted from the second heat dissipation member 212 in the opposite direction of the x direction, and is disposed so as to overlaps with the first heat dissipation member 211 in the z direction. The fourth heat dissipation member 214 receives heat from the fourth laser devices 21R4. That is, the heat of the fourth laser devices 21R4 is transferred to the fourth heat dissipation member 214.

The fourth heat dissipation member 214 is, for example, a rectangular-box-shaped heat sink 124 and has two rectangular end surfaces parallel to each other and four side surfaces that couple four sides of one of the two end surfaces to those of the other. The two end surfaces of the heat sink 124 are, for example, parallel to the xy plane. Two of the four side surfaces of the heat sink 124 are parallel to the xz plane. The other two of the four side surfaces of the heat sink 124 are parallel to the yz plane. For example, one fourth laser device 21R4 is disposed in the x direction, and two or more fourth laser devices 21R4 are disposed at intervals in the y direction at an end surface 124e, which faces the +z direction, out of the two end surfaces of the heat sink 124. The end surface 124e is the surface of the heat sink 124 that faces the light combining member 24.

The light emission surface of each of the fourth laser devices 21R4 is parallel to the xy plane, and is the surface of the fourth laser device 21R4 that is opposite from the surface in contact with the end surface 124e of the heat sink 124. The fourth laser devices 21R4 in light emission operation are heated by a voltage supplied from the power supply, which is not shown. At least part of the heat of the fourth laser devices 21R4 is dissipated via the heat sink 124 adjacent thereto. The fourth laser devices 21R4 emit t red light LR4 having a wavelength λR4 at an operating temperature T4 higher than the operating temperature T2. The wavelength λR4 falls within the fourth wavelength band of the red light LR, is longer than the wavelengths λR1, λR2, and λR13, and is longer than the wavelength λR3. That is, the wavelength of the red light LR4 emitted by the fourth laser devices 21R4 increases from the wavelength λR13 to the wavelength λR4 as the operating temperature of the fourth laser devices 21R4 rises. The heat sink 124 has a heat dissipation capability of stabilizing the temperature of the fourth laser devices 21R4 in light emission operation at the operating temperature T4. The heat sink 124 is sized in each of the x, y, and z directions so as to exhibit the heat dissipation capability of stabilizing the temperatures of the plurality of fourth laser devices 21R4 in light emission operation at the operating temperature T4.

The heat dissipation capability of the heat sink 124, which is the fourth heat dissipation member 214, differs from the heat dissipation capability of the heat sink 123. For example, since the operating temperature T4 is higher than the operating temperatures T1, T2, and T3, (T4−T0)>(T2−T0)>(T3−T0)>(T1−T0) is satisfied. In this case, the heat dissipation capability of the heat sink 124 is smaller than the heat dissipation capability of the heat sink 122. Specifically, the sizes of the heat sink 124 in the x and y directions are comparable to the sizes of the heat sinks 121 and 122 in the x and y directions. The size of the heat sink 124 in the z direction is smaller than the size of the heat sink 122 in the z direction.

The third laser devices 21R3 each emit the red light LR3 via the light emission surface radially with the z direction being the center axis of the radial light emission. The fourth laser devices 21R4 each emit the red light LR4 via the light emission surface radially with the z direction being the center axis of the radial light emission. As an example, the wavelength λR11 of the light from the first laser devices 21R1 and the second laser devices 21R2 at the operating temperature T0 is 638 nm, and the wavelength λR13 of the light from the third laser devices 21R3 and the fourth laser devices 21R4 at the operating temperature T0 is 642 nm. The operating temperature T1 is 40° C., and the wavelength λR1 of the light from the first laser devices 21R1 at the operating temperature T1 is 639 nm. The operating temperature T2 is 50° C., and the wavelength λR2 of the light from the second laser devices 21R2 at the operating temperature T2 is 641 nm. The operating temperature T3 is 45° C., and the wavelength λR3 of the light from the third laser devices 21R3 at the operating temperature T3 is 644 nm. The operating temperature T4 is 55° C., and the wavelength λR4 of the light from the fourth laser devices 21R4 at the operating temperature T4 is 646 nm.

In the case described above, the difference in wavelength (λR13−λR11) between the peak wavelength of the light from each of the first laser devices 21R1 in oscillation and the peak wavelength of the light from of each of the fourth laser devices 21R4 in oscillation at the operating temperature T0 is 4 nm. The heat sink 123 is coupled to the third laser devices 21R3, and the heat sink 124 is coupled to the fourth laser devices 21R4. The difference in wavelength (λR4−λR1) between the red light LR1, which is emitted from the first laser devices 21R1 and has the first wavelength band at the operating temperature T1, and the red light LR4, which is emitted from the fourth laser devices 21R4 and has the fourth wavelength band at the operating temperature T4, is therefore 7 nm, which is greater than the difference in wavelength (λR13−λR11).

Furthermore, as the operation of the illuminator 102 continues, the temperatures of the first laser devices 21R1 to the fourth laser devices 21R4 rise, and the state of the first light source 20R changes from the state in which the first light source 20R outputs the red light LR having the two kinds of wavelengths λR11 and λR13 at the operating temperature T0 to the state in which the first light source 20R outputs the red light LR having the four kinds wavelengths λR1, λR2, λR3, and λR4. That is, the number of types of wavelength contained in the red light LR increases from two to four.

The number of first collimation lenses 22R is equal to the total number of first laser devices 21R1, second laser devices 21R2, third laser devices 21R3, and fourth laser devices 21R4. The first collimation lenses 22R are disposed in the optical path of the red light LR1 emitted from the first laser devices 21R1, in the optical path of the red light LR2 emitted from the second laser devices 21R2, in the optical path of the red light LR3 emitted from the third laser devices 21R3, and in the optical path of the red light LR4 emitted from the fourth laser devices 21R4. The center of each of the first collimation lenses 22R in the x direction substantially coincides with any one of the center of the light emission surface of the first laser device 21R1 corresponding to the first collimation lens 22R, the center of the light emission surface of the second laser device 21R2 corresponding thereto, the center of the light emission surface of the third laser device 21R3 corresponding thereto, and the center of the light emission surface of the fourth laser device 21R4 corresponding thereto.

The first collimation lenses 22R each parallelize any one of the red light LR1, the red light LR2, the red light LR3, and, the red light LR4 incident thereon. The red light LR1, the red light LR2, the red light LR3, and the red light LR4 parallelized by the first collimation lenses 22R travel along the z direction. An optical axis AX1 of the red light LR output from the first light source 20R is parallel to the z direction.

The second light source 20G is disposed at a position shifted from the first light source 20R in the opposite direction of the x direction. The second light source 20G includes laser devices 21G and the second collimation lenses 22G, and outputs the green light LG.

The second light source 20G includes, for example, four laser devices 21G. The four laser devices 21G are disposed at intervals in the z direction. The light emission surface of each of the laser devices 21G is parallel to the yz plane. The laser devices 21G each emit the green light LG in the x direction radially with the z direction being the center axis of the radial light emission.

The number of second collimation lenses 22G is equal to the total number of laser devices 21G. The second collimation lenses 22G are disposed in the optical path of the green light LG emitted from the laser devices 21G. The center of each of the second collimation lenses 22G in the x direction substantially coincides with the center of the light emission surface of the laser device 21G corresponding to the second collimation lens 22G.

The second collimation lenses 22G parallelize the green light LG incident thereon. The green light LG parallelized by the second collimation lenses 22G travels along the x direction. An optical axis AX2 of the green light LG output from the second light source 20G is parallel to the x direction. The optical axis AX2 of the green light LG is perpendicular to the optical axis AX1 of the red light LR.

As described in the first embodiment, in the case where speckle noise produced by the green light LG is apparent, the second light source 20G may be configured the same as the first light source 20R and may include the laser devices 21G that emit the green light LG having different wavelengths at the operating temperature T0, and a heat dissipation member that is coupled to the laser devices 21G and transfers the heat of the laser devices 21G.

The illuminator 102 according to the second embodiment described above includes the first light source 20R, the second light source 20G, the light combining member 24, the diffuser 40, the light collector 25, and the collimator 26. In the illuminator 102 according to the second embodiment, when the white light WL output from the illuminator 102 is projected, speckle noise that appears in a projection image can be favorably reduce, as in the illuminator 2 according to the first embodiment.

In the illuminator 102 according to the second embodiment, the first light source 20R further includes the plurality of third laser devices (third light emitters) 21R3, the plurality of fourth laser devices (fourth light emitters) 21R4, the third heat dissipation member 213, and the fourth heat dissipation member 214. The third laser devices 21R3 each emit the red light LR3 having the third wavelength band. The fourth laser devices 21R4 each emit the red light LR4 having the fourth wavelength band different from the third wavelength band. That is, the heat of the plurality of third laser devices 21R3 is transferred to the third heat dissipation member 213. The heat of the plurality of fourth laser devices 21R4 is transferred to the fourth heat dissipation member 214. The wavelengths in the first wavelength band are shorter than those in the second wavelength band, and the wavelengths in the third wavelength band are shorter than those in the fourth wavelength band. The wavelengths in the first and second wavelength bands are shorter than those in the third and fourth wavelength bands. The heat dissipation capability of the first heat dissipation member 211 is greater than the heat dissipation capability of the second heat dissipation member and 212, greater than the heat dissipation capability of the third heat dissipation member 213. The heat dissipation capability of the second heat dissipation member 212 is greater than the heat dissipation capability of the fourth heat dissipation member 214 but smaller than or equal to the heat dissipation capability of the third heat dissipation member 213. The heat dissipation capability of the third heat dissipation member 213 is greater than the heat dissipation capability of the fourth heat dissipation member 214.

In the illuminator 102 according to the second embodiment, the heat dissipation via the first heat dissipation member 211 allows the first laser devices 21R1 to emit the red light LR1 at the operating temperature T1. The heat dissipation via the second heat dissipation member 212 allows the second laser devices 21R2 to emit the red light LR2 at the operating temperature T2. The heat dissipation via the third heat dissipation member 213 allows the third laser devices 21R3 to emit the red light LR3 at the operating temperature T3. The heat dissipation via the fourth heat dissipation member 214 allows the fourth laser devices 21R4 to emit the red light LR4 at the operating temperature T4. Accordingly, the number of wavelengths of the red light LR contained in the white light WL diffused by the diffuser 40 and entering the optical integration system 50 increases to four, and the difference in wavelength (λR4−λR1) associated with the red light LR becomes greater than the difference in wavelength (λR14−λR11), so that the speckle noise produced by the white light WL is favorably reduced. In the illuminator 102 according to the second embodiment, when the white light WL output from the illuminator 2 is projected, speckle noise that appears in a projection image can be reduced favorably and effectively.

Furthermore, in the illuminator 102 according to the second embodiment, not only does the difference in wavelength associated with the red light LR increase as described above, and the wavelength of the red light LR is multiplexed. The wavelength band of the red light LR is multiplexed by the four wavelength bands, the first to fourth wavelength bands of the red light LR1, LR2, LR3, and LR4. Therefore, in the illuminator 102 according to the second embodiment, the wavelength band of the red light LR is broader than in the case where the wavelength of the red light LR is multiplexed by the two wavelength bands, the first wavelength band of the red light LR1 and the second wavelength band of the red light LR2 as in the illuminator 2 according to the first embodiment, so that the speckle noise produced by the white light WL can be favorably reduced.

In the first light source 20R of the illuminator 102 according to the second embodiment, the arrangement of the first laser devices 21R1 and the first heat dissipation member 211, the second laser devices 21R2 and the second heat dissipation member 212, the third laser devices 21R3 and the third heat dissipation member 213, and the fourth laser devices 21R4 and the fourth heat dissipation member 214 in the x direction may be freely changed. For example, the first laser devices 21R1 and the first heat dissipation member 211, the second laser devices 21R2 and the second heat dissipation member 212, the third laser devices 21R3 and the third heat dissipation member 213, and the fourth laser devices 21R4 and the fourth heat dissipation member 214 may be sequentially arranged along the x direction. Any of the aforementioned arrangements of the laser devices and the heat dissipation members provides the same effects as those provided by the illuminator 102 according to the second embodiment described above.

In the illuminator 2 according to the first embodiment, the number of third laser devices 21R3 in the x direction and the number of third laser devices 21R3 in the y direction at the end surface 123e of the heat sink 123 may be changed and are appropriately set. Similarly, the number of fourth laser devices 21R4 in the x direction and the number of fourth laser devices 21R4 in the y direction at the end surface 124e of the heat sink 124 may be changed and are appropriately set.

### Third Embodiment

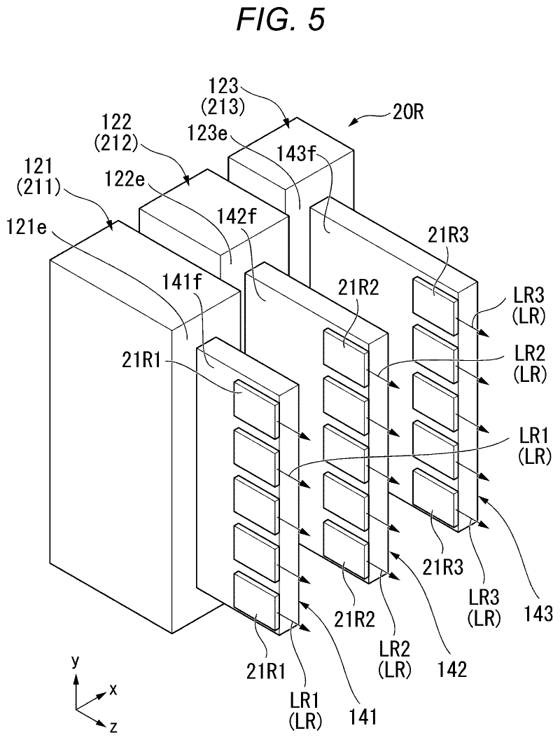

The illuminator according to a third embodiment of the present disclosure will be subsequently described with reference to FIGS. 5 to 8. In the description of the third embodiment, the contents common to those in the first and second embodiments are omitted, and configurations and contents different from those already described in the first and second embodiments are described.

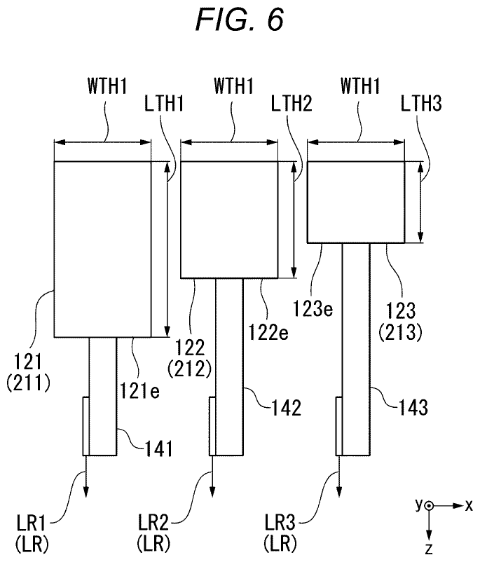

FIG. 5 is a perspective view showing the configuration of the first light source 20R of the illuminator according to the third embodiment. FIG. 6 is a plan view of the first light source 20R of the illuminator according to the third embodiment. In the third embodiment, the first light source 20R includes the plurality of first laser devices 21R1, the plurality of second laser devices 21R2, the plurality of third laser devices 21R3, the first heat dissipation member 211, the second heat dissipation member 212, the third heat dissipation member 213, and the first collimation lenses 22R. In FIGS. 5 and 6, the first collimation lenses 22R are omitted.

In the third embodiment, the plurality of first laser devices 21R1, the plurality of second laser devices 21R2, and the plurality of third laser devices 21R3 are each configured as a single package.

The plurality of first laser devices 21R1 are mounted on a plate surface 141f of a base substrate 141 in the package that is parallel to the yz plane, as shown in FIGS. 5 and 6. For example, five first laser devices 21R1 are arranged at intervals in the y direction at the plate surface 141f of the base substrate 141. Circuits and electronic parts that are not shown but drive the first laser devices 21R1 are disposed at the plate surface 141f of the base substrate 141. The light emission surface of each of the first laser devices 21R1 is the end surface thereof parallel to the xy plane and facing the +z direction.

The base substrate 141 is coupled to the end surface 121e of the heat sink 121, which is the first heat dissipation member 211. The heat of the five first laser devices 21R1 is transferred to the heat sink 121 via the base substrate 141.

The plurality of second laser devices 21R2 are mounted on a plate surface 142f of a base substrate 142 in the package that is parallel to the yz plane. For example, five second laser devices 21R2 are disposed at intervals in the y direction at the plate surface 142f of the base substrate 142. Circuits and electronic parts that are not shown but drive the second laser devices 21R2 are disposed at the plate surface 142f of the base substrate 142. The light emission surface of each of the second laser devices 21R2 is the end surface thereof parallel to the xy plane and facing the +z direction.

The base substrate 142 is coupled to the end surface 122e of the heat sink 122, which is the second heat dissipation member 212. The heat of the five second laser devices 21R2 is transferred to the heat sink 122 via the base substrate 142.

The plurality of third laser devices 21R3 are mounted on a plate surface 143f of a base substrate 143 in the package that is parallel to the yz plane. For example, five third laser devices 21R3 are disposed at intervals in the y direction at the plate surface 143f of the base substrate 143. Circuits and electronic parts that are not shown but drive the third laser devices 21R3 are disposed at the plate surface 143f of the base substrate 143. The light emission surface of each of the third laser devices 21R3 is the end surface thereof parallel to the xy plane and facing the +z direction.

The base substrate 143 is coupled to the end surface 123e of the heat sink 123, which is the third heat dissipation member 213. The heat of the five third laser devices 21R3 is transferred to the heat sink 123 via the base substrate 143.

The heat sinks 121, 122, and 123 have the same width WTH1 in the x direction, as shown in FIG. 6. A length LTH2 of the heat sink 122 in the z direction is shorter than a length LTH1 of the heat sink 121 in the z direction. A length LTH3 of the heat sink 123 in the z direction is shorter than the length LTH2 of the heat sink 122 in the z direction. The heat sinks 121, 122, and 123 have the same height in the y direction. The lengths of the base substrates 141, 142, and 143 in the z direction are adjusted as appropriate in accordance to the relative positions of the end surfaces 121e, 122e, and 123e of the heat sinks 121, 122, and 123, for example, in such a way that the light emission surfaces of the first laser devices 21R1, the light emission surfaces of the second laser devices 21R2, and the light emission surfaces of the third laser devices 21R3 are located at the same position in the z direction.

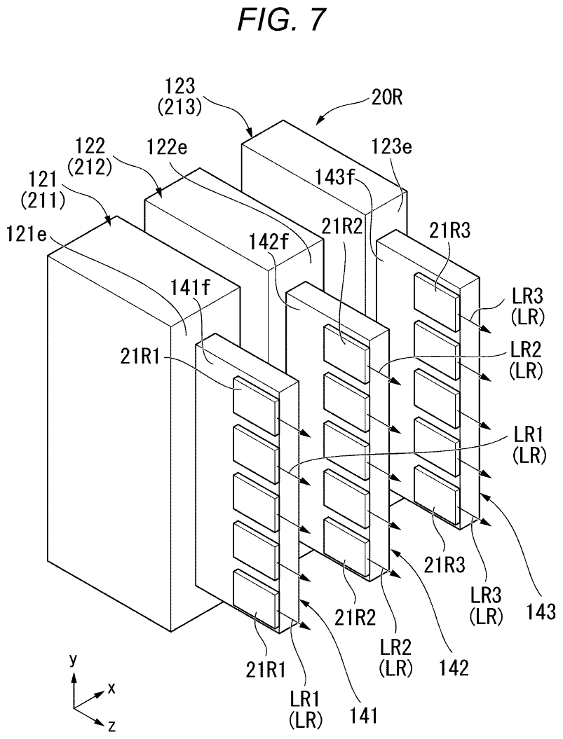

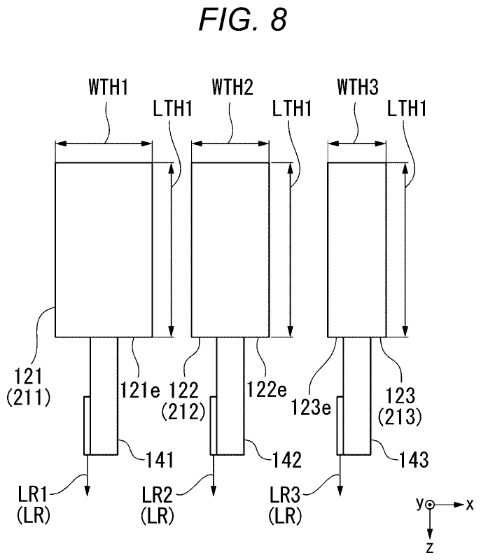

FIG. 7 is a perspective view showing the configuration of a variation of the first light source 20R of the illuminator according to the third embodiment. FIG. 8 is a plan view of the variation of the first light source 20R of the illuminator according to the third embodiment. As the variation of the first light source 20R of the illuminator according to the third embodiment, a width WTH2 of the heat sink 122 in the x direction may be shorter than the width WTH1 of the heat sink 121 in the x direction, as shown in FIGS. 7 and 8. A width WTH3 of the heat sink 123 in the x direction may be shorter than the width WTH2 of the heat sink 122 in the x direction. The lengths LTH1, LTH2, and LTH3 of the heat sinks 121, 122, and 123 in the z direction are equal to each other.

In the illuminator according to the third embodiment described above, the plurality of first laser devices (first light emitters) 21R1 are arranged one-dimensionally along the y direction. The plurality of second laser devices (second light emitters) 21R2 are arranged one-dimensionally along the y direction. The plurality of first laser devices 21R1 and the plurality of second laser devices 21R2 are components separate from each other. The plurality of first laser devices 21R1 form a single package. The plurality of second laser devices 21R2 form a single package.

In the illuminator according to the third embodiment, since the plurality of first laser devices 21R1 are packaged, and the plurality of second laser devices 21R2 are packaged separately from the plurality of first laser devices 21R1, the first laser devices 21R1 and the second laser devices 21R2 can be readily combined with the first heat dissipation member 211 and the second heat dissipation member 212, respectively, to form the first light source 20R.

In the first light source 20R of the illuminator according to the third embodiment, the number of first collimation lenses 22R is equal to the total number of first laser devices 21R1, second laser devices 21R2, and third laser devices 21R3. The plurality of first collimation lenses 22R may be disposed separately from the package of the plurality of first laser devices 21R1, the package of the plurality of second laser devices 21R2, and the package of the plurality of third laser devices 21R3 at positions shifted from the light emission surfaces of the laser devices toward the +z direction, or may be incorporated in the packages of the laser devices.

It is conceivable in the first light source 20R of the illuminator according to the third embodiment that there is a case where the paths of the red light LR1 emitted from the plurality of first laser devices 21R1, the red light LR2 emitted from the plurality of second laser devices 21R2, and the red light LR3 emitted from the plurality of third laser devices 21R3 are adjusted in the x, y, and z directions. In this case, optical elements such as mirrors that deflect the red light LR may be disposed as appropriate between the surface of the light combining member 24 on which the red light LR is incident and the light emission surfaces via which the red light LR the path of which is to be adjusted exits, out of the light emission surfaces of the plurality of first laser devices 21R1, the light emission surfaces of the plurality of second laser devices 21R2, and the light emission surfaces of the plurality of third laser devices 21R3.

Preferable embodiments of the present disclosure have been described above in detail. The present disclosure is, however, not limited to a specific embodiment, and a variety of modifications and changes can be made to the embodiments within the scope of the substance of the present disclosure described in the claims.

For example, the shapes, the numbers, the arrangements, the materials, and other factors of the components of the illuminator and the projector are not limited to those described in the aforementioned embodiments and variations thereof, and may be changed as appropriate.

In the embodiments described above, which describe the illuminator according to the present disclosure, an example of the reflective diffuser has been presented as the diffuser, but not necessarily. For example, the illuminator according to the present disclosure may include a transmissive diffuser as the diffuser. In this case, the substrate of the diffuser is provided with no reflection film. The combined light having been diffused by the diffusion surface of the substrate of the diffuser and having passed through the substrate is output via the light exiting surface of the substrate along the optical axis that coincides with the optical axis of the combined light incident on the substrate. In the embodiments described above, in which the diffuser is a reflective diffuser, the disturbance of the polarization of the combined light output from the diffuser is smaller than the disturbance that occurs in a transmissive diffuser.

The aforementioned embodiments have been described with reference to the case where the illuminator according to the present disclosure is incorporated in a projector using liquid crystal panels, but not necessarily. For example, the illuminator according to the present disclosure may be used in a projector using a digital micromirror device as each of the light modulators. The projector according to the present disclosure may not include a plurality of light modulators and may instead be a single-panel projector including only one light modulator.

### SUMMARY OF PRESENT DISCLOSURE

The present disclosure will be summarized below as additional remarks. As additional remark 1, an illuminator includes: a first light source that outputs first light having a first color; a second light source that outputs second light having a color different from the first color; a light combining member that combines the first light and the second light with each other and outputs the combined light; a diffuser including a substrate having a diffusion surface that diffuses the combined light incident thereon and outputs the diffused combined light, and a driver that rotates the substrate; a light collector that is disposed between the light combining member and the diffuser, collects the combined light, and causes the collected combined light to be incident on the diffusion surface of the diffuser; and a collimator that parallelizes the combined light output from the diffuser. The first light source includes a plurality of first light emitters that each emit the first light having a first wavelength band, a plurality of second light emitters that each emit the first light having a second wavelength band different from the first wavelength band, a first heat dissipation member to which heat of the plurality of first light emitters is transferred, and a second heat dissipation member to which heat 4 the plurality of second light emitters is transferred, and a heat dissipation capability of the first heat dissipation member and a heat dissipation capability of the second heat dissipation member differ from each other.

According to the configuration described in the additional remark 1, the difference in wavelength between the first light emitted from the first light emitters and the first light emitted from the second light emitters can be increased by the first and second heat dissipation members, so that the combined light that produces a reduced amount of speckle noise is allowed to enter the diffuser and the downstream optical system, as compared with the illuminator of related art. The configuration described in the additional remark 1 can therefore favorably reduce the speckle noise that appears in a projection image when the combined light output from the illuminator is projected.

As additional remark 2, in the illuminator according to the additional remark 1, wavelengths in the first wavelength band are shorter than wavelengths in the second wavelength band, and the heat dissipation capability of the first heat dissipation member is greater than the heat dissipation capability of the second heat dissipation member.

According to the configuration described in the additional remark 2, the difference in wavelength between the first light emitted from the first light emitters and the first light emitted from the second light emitters and having a wavelength band including wavelengths longer than those in the wavelength band of the first light emitted from the first light emitters can be increased by the first and second heat dissipation members. The configuration described above can therefore temporally change the diffusion, scattering, or diffraction pattern and the speckle pattern in the combined light spot formed at the diffusion surface of the diffuser.

As additional remark 3, in the illuminator according to the additional remark 2, the first heat dissipation member includes a first heat sink including a plurality of first fins, the second heat dissipation member includes a second heat sink including a plurality of second fins, and the first heat sink is larger than the second heat sink.

According to the configuration described in the additional remark 3, the difference in wavelength between the first light emitted from the first light emitters and the first light emitted from the second light emitters can be increased by the first and second heat dissipation members.

As additional remark 4, in the illuminator according to the additional remark 2 or 3, the first heat dissipation member includes a first heat sink including a plurality of first fins, the second heat dissipation member includes a second heat sink including a plurality of second fins, and the number of first fins is greater than the number of second fins.

According to the configuration described in the additional remark 4, the difference in wavelength between the first light emitted from the first light emitters and the first light emitted from the second light emitters can be increased by the first and second heat dissipation members.

As additional remark 5, in the illuminator according to any of the additional remarks 1 to 4, the first heat dissipation member includes a first heat sink including a plurality of first fins and a third heat sink including a plurality of third fins, the second heat dissipation member includes a second heat sink including a plurality of second fins, and the first and third heat sinks are coupled to each other via a heat transport member.

According to the configuration described in the additional remark 5, the third heat sink is thermally coupled to the first heat sink to adjust the wavelength of the first light emitted from the first light emitters, so that the difference in wavelength between the first light emitted from the first light emitters and the first light emitted from the second light emitters can be increased by the first and second heat dissipation members.

As additional remark 6, in the illuminator according to any of the additional remarks 1 to 5, the plurality of first light emitters are arranged one-dimensionally, the plurality of second light emitters are arranged one-dimensionally, the plurality of first light emitters and the plurality of second light emitters are components separate from each other, the plurality of first light emitters form a single package, and the plurality of second light emitters form a single package.

According to the configuration described in the additional remark 6, the first heat dissipation member can be readily coupled to the packaged first light emitters, so that the wavelength of the first light emitted from the first light emitters can be set and adjusted. The second heat dissipation member can be readily coupled to the packaged second light emitters, so that the wavelength of the second light emitted from the second light emitters can be set and adjusted.

As additional remark 7, in the illuminator according to any of the additional remarks 1 to 6, the first light source further includes a plurality of third light emitters that each emit the first light having a third wavelength band, a plurality of fourth light emitters that each emit the first light having a fourth wavelength band different from the third wavelength band, a third heat dissipation member to which heat of the plurality of third light emitters is transferred, and a fourth heat dissipation member to which heat of the plurality of fourth light emitters is transferred, wavelengths in the first wavelength band are shorter than wavelengths in the second wavelength band, wavelengths in the third wavelength band are shorter than wavelengths in the fourth wavelength band, the wavelengths in the first and second wavelength bands are shorter than the wavelengths in the third and fourth wavelength bands, the heat dissipation capability of the first heat dissipation member is greater than the heat dissipation capability of the second heat dissipation member and greater than a heat dissipation capability of the third heat dissipation member, the heat dissipation capability of the second heat dissipation member is greater than a heat dissipation capability of the fourth heat dissipation member but smaller than or equal to the heat dissipation capability of the third heat dissipation member, and the heat dissipation capability of the third heat dissipation member is greater than the heat dissipation capability of the fourth heat dissipation member.

According to the configuration described in the additional remark 7, the first light having the four types of wavelength bands is generated, the maximum difference in wavelength between the first light emitted from the first light emitters and the first light emitted from the fourth light emitters is increased by the first and fourth heat dissipation members, so that the combined light that produces a reduced amount of speckle noise is allowed to enter the diffuser and the downstream optical system, as compared with the illuminator of related art. The configuration described in the additional remark 7 can therefore favorably reduce the speckle noise that appears in a projection image when the combined light output from the illuminator is projected.

As additional remark 8, in the illuminator according to any of the additional remarks 1 to 7, the first color is red.

Among the three primary colors, speckle noise caused by red light is most likely to apparent. The configuration described in the additional remark 8 allows the combined light that produces an effectively reduced amount of speckle noise to enter the diffuser and the downstream optical system. The configuration described in the additional remark 8 can therefore favorably reduce the speckle noise that appears in a projection image when the combined light output from the illuminator is projected.

As additional remark 9, a projector includes the illuminator described in any one of the additional remarks 1 to 8, a light modulator that modulates light output from the illuminator, and a projection system that projects the light modulated by the light modulator.

The configuration described in the additional remark 9 can favorably reduce the speckle noise that appears in a projection image when the combined light output from the illuminator is converted by the light modulator into image light and the image light is projected.

What is claimed is:

1. An illuminator comprising:
a first light source that emits first light having a first color;
a second light source that emits second light having a color different from the first color;
a light combining member that combines the first light and the second light with each other and emits the combined light;
a diffuser including a substrate having a diffusion surface that diffuses the combined light incident thereon and emits the diffused combined light, and a driver that rotates the substrate;
a light collector that is disposed between the light combining member and the diffuser, collects the combined light, and causes the collected combined light to be incident on the diffusion surface of the diffuser; and
a collimator that parallelizes the combined light emitted from the diffuser,
wherein the first light source includes
a plurality of first light emitters that each emit the first light having a first wavelength band,
a plurality of second light emitters that each emit the first light having a second wavelength band different from the first wavelength band,
a first heat dissipation member to which heat of the plurality of first light emitters is transferred, and
a second heat dissipation member to which heat of the plurality of second light emitters is transferred, and
a first heat dissipation capability of the first heat dissipation member and a second heat dissipation capability of the second heat dissipation member differ from each other.

2. The illuminator according to claim 1, wherein
wavelengths in the first wavelength band are shorter than wavelengths in the second wavelength band, and
the first heat dissipation capability of the first heat dissipation member is greater than the second heat dissipation capability of the second heat dissipation member.

3. The illuminator according to claim 2, wherein
the first heat dissipation member includes a first heat sink including a plurality of first fins,
the second heat dissipation member includes a second heat sink including a plurality of second fins, and
the first heat sink is larger than the second heat sink.

4. The illuminator according to claim 2, wherein
the first heat dissipation member includes a first heat sink including a plurality of first fins,
the second heat dissipation member includes a second heat sink including a plurality of second fins, and
the number of first fins is greater than the number of second fins.

5. The illuminator according to claim 2, wherein
the first heat dissipation member includes a first heat sink including a plurality of first fins and a third heat sink including a plurality of third fins,
the second heat dissipation member includes a second heat sink including a plurality of second fins, and
the first and third heat sinks are coupled to each other via a heat transport member.

6. The illuminator according to claim 1, wherein
the plurality of first light emitters are arranged one-dimensionally,
the plurality of second light emitters are arranged one-dimensionally,
the plurality of first light emitters and the plurality of second light emitters are components separate from each other,
the plurality of first light emitters form a single package, and
the plurality of second light emitters form a single package.

7. The illuminator according to claim 1, wherein
the first light source further includes
a plurality of third light emitters that each emit the first light having a third wavelength band,
a plurality of fourth light emitters that each emit the first light having a fourth wavelength band different from the third wavelength band,
a third heat dissipation member to which heat of the plurality of third light emitters is transferred, and
a fourth heat dissipation member to which heat of the plurality of fourth light emitters is transferred,
wavelengths in the first wavelength band are shorter than wavelengths in the second wavelength band,
wavelengths in the third wavelength band are shorter than wavelengths in the fourth wavelength band,
the wavelengths in the first and second wavelength bands are shorter than the wavelengths in the third and fourth wavelength bands,
the first heat dissipation capability of the first heat dissipation member is greater than the second heat dissipation capability of the second heat dissipation member and greater than a third heat dissipation capability of the third heat dissipation member,
the second heat dissipation capability of the second heat dissipation member is greater than a fourth heat dissipation capability of the fourth heat dissipation member but smaller than or equal to the third heat dissipation capability of the third heat dissipation member, and
the third heat dissipation capability of the third heat dissipation member is greater than the fourth heat dissipation capability of the fourth heat dissipation member.

8. The illuminator according to claim 1, wherein
the first color is red.

9. A projector comprising:
the illuminator according to claim 1,
a light modulator that modulates light emitted from the illuminator, and
a projection system that projects the light modulated by the light modulator.
